(19) United States
(12) Patent Application Publication
(10) Pub. No.: US 2018/0352740 A1
(43) Pub. Date: Dec. 13, 2018

(54) Device for Harvesting Stalk-Like Stem Crops with Adjustable Picking Plates

(71) Applicant: Carl Geringhoff GmbH & Co. KG, Ahlen (DE)

(72) Inventors: Bernd Albinger, Bad Saulgau (DE); Andre Hemmesmann, Sassenberg (DE); Martin Beumker, Wadersloh (DE)

(21) Appl. No.: 15/758,376

(22) PCT Filed: Sep. 22, 2016
(86) PCT No.: PCT/EP2016/001585

§ 371 Date: Jul. 28, 2018

(30) Foreign Application Priority Data
Sep. 28, 2015 (DE) 10 2015 116 375.6

(51) Int. Cl. A01D 45/02

(52) U.S. Cl. CPC A01D 45/021

(57) ABSTRACT

The present invention relates to a device for harvesting stalk-like stem crops, having a number of picking units (2) which are arranged alongside one another on the frame of the device and each have picking plates (6), which laterally delimit a picking gap (4) and are adjustable in the transverse direction, and at least one picking rotor (8) located therebeneath, conveying units (10) which are assigned to the respective picking units (2), are configured as continuous conveyors that are driven in circulation, are arranged on opposite sides above a picking gap (4) and are configured with drivers fastened to the circulating elements, and a transverse conveying device arranged downstream of the conveying units (10), wherein the transverse adjustment of the picking plates (6) takes place by means of anchor plates (12) which are movable in rotation about an axis of rotation (14) by an adjusting lever (20). In order to create an adjusting mechanism which requires a smaller overall width, it is proposed that one or more anchor plates (12) each have two joint axes (16) via which the adjacent picking plates (6) are connected to these armature plates (12), and that the two picking plates (6) be movable in the transverse direction via the joint axes (16) in the event of a rotary movement of these anchor plates (12) about their axes of rotation.

The present invention relates to a device for harvesting stalk-like stem crops, said device having
a number of picking units, which are arranged side by side on the frame of the device and which each have picking plates that laterally delimit a picking gap and are adjustable in the transverse direction, and at least one picking rotor located therebeneath,
conveying units, which are assigned to the respective picking units, are embodied as continuous conveyors that are driven in circulation, are arranged on opposite sides above a picking gap, and have carrier elements attached to the circulating conveyors, and
a transverse conveying device located downstream of the conveying units, wherein the transverse adjustment of the picking plates is carried out by means of anchor plates, which can be moved in rotation about an axis of rotation by means of an adjusting lever.
   For the most part, the devices in question for harvesting stalk-like stem crops are installed on combine harvesters as corn picker heads for harvesting corn grain. In the corn picker heads, the ears of corn are separated from the stalks, the stalks and leaves are discarded onto the ground, and the picked ears of corn are delivered to the combine harvester for threshing.

In the picking operation, the plant stalks are pushed down by at least one picking rotor once the plant stalk has entered the picking gap, which is delimited by at least one laterally disposed picking plate. When an ear of corn attached to the corn stalk reaches the picking gap, it becomes caught on the picking plate(s), whereas the stalk is carried further downward because it is wider than the picking gap. This causes the ear of corn to tear away from the stalk.

However, this operation will work only if the picking gap is narrower than the ear of corn. And the picking gap must nevertheless be wide enough that it will not impede the intake of the cornstalks. Since the thickness of cornstalks and ears of corn varies according to corn variety, field and growing conditions, it is known to arrange the picking plates adjustably in the device. The carrier elements circulating continuously with the circulating conveyors catch the separated ears of corn and feed them to the transverse auger, which collects the separated ears of corn at the center of the device and delivers them rearward to the combine harvester.

The devices known from the prior art for adjusting picking plates require a certain amount of installation space and space for movement between the picking rows. A further impediment to such movement is presented, in particular, by the longitudinal beams, which are located between adjacent picking rows.

In a device of the type in question, disclosed in U.S. Pat. No. 5,680,750, an adjusting mechanism is used, in which for each picking plate, an adjusting lever positioned below the level of the picking plates acts on a first rotatory anchor plate that is connected to the picking plate. The anchor plate has a joint axis which is eccentric to the axis of rotation of the anchor plate and via which the anchor plate is connected to the associated picking plate. A rotatory movement of the anchor plate generated by the adjusting lever is transmitted to the picking plate via the joint axis. A further joint axis connects the first anchor plate to a linkage, by means of which the rotatory movement of the first anchor plate generated by the adjusting lever is transmitted to a second anchor plate located further forward toward the tip of the picker. The second anchor plate is likewise equipped with a joint axis which is disposed eccentrically to the axis of rotation of the anchor plate and is connected to the picking plate. The rotatory movement of the two anchor plates causes a parallel displacement of the picking plate. The appropriately synchronized rotatory movement of the anchor plates, each of which is supported on a fixed axis of rotation, causes a linear displacement of the picking plates connected to said anchor plates, transversely to the picking gap.

The device known from the prior art is designed for use with 30-inch row widths of the stalk-like stem crop and functions satisfactorily for this purpose. Now, however, halved row widths of 15 inches for the cultivation of stalk-like stem crops are being recommended in the farming industry. And the conventional technique for adjusting picking plates cannot be used with such narrow row widths because it requires too much overall width, especially if both picking plates of a picking row are to be adjusted in the transverse direction. Moreover, the known device is relatively complex.

It is therefore the object of the present application to provide an adjustment mechanism that requires a smaller overall width. As an additional object, efforts are made to reduce the technical complexity of the adjustment mechanism.

The object is achieved for a device of the type in question in that one or more anchor plates each have two joint axes via which adjacent picking plates are connected to said anchor plates, and in that the two picking plates are movable in the transverse direction via the joint axes when these anchor plates are rotated about their axes of rotation.

The solution according to the invention enables two picking plates to be adjusted simultaneously via one anchor plate. The left picking plate of a right picking row and the right picking plate of a left picking row, the two picking rows being adjacent, are considered to be adjacent picking plates.

The use of one anchor plate for the transverse adjustment of two adjacent picking plates opens up two possible uses: In a first configuration, one picking gap is equipped with two adjustable picking plates per row. In this configuration, in arithmetic terms, only one anchor plate adjustment mechanism is required per row, with each anchor plate adjustment mechanism acting on one of two picking plates in a picking row. The two picking plates of a picking row are thus adjusted from two sides by one anchor plate adjustment mechanism on each side, with each such adjustment mechanism also adjusting a picking plate in an adjacent picking row. In a second configuration, a picking gap is equipped with one adjustable and one fixed picking plate per picking row. In that case, an anchor plate adjustment mechanism is required only for every other row, with said adjustment mechanism likewise acting on one of two picking plates in a picking row and also adjusting a picking plate in an adjacent picking row.

In principle, it is possible for two picking plates to be adjusted in a transverse direction using only a single anchor plate, as long as the picking plates are equipped with a corresponding guide in which they cannot tilt and become jammed. Since the picking plates extend over the full length of a picking gap, however, if only one anchor plate is used for transverse adjustment, substantial lever forces acting on the adjustment mechanism may result, which might impair the long-term problem-free functioning of transverse adjustment under difficult harvesting conditions. It is therefore also possible for two anchor plates to be provided per picking plate, these being arranged along the picking gap to the front and the rear of a picking plate and being connected to one another via a connecting rod, so that a synchronous rotatory movement of both anchor plates acting on a picking plate is produced when the adjusting lever executes an adjusting movement.

The use of only one anchor plate adjustment mechanism to adjust two picking plates decreases the number of anchor plate adjustment mechanisms to be installed in a device by half. The overall width of the device is decreased considerably as a result. In addition, the mechanical complexity of the device is reduced, and the weight of the device is decreased due to the decreased number of adjustment mechanisms.

In the two outer picking rows of a corn picker, the picking plate positioned on the outside in each case has no adjacent picking plate, and therefore, either no adjustment is provided for the picking plates in these locations, or the adjustment is made via a mechanism that does not use an anchor plate having two joint axes via which adjacent picking plates are connected to said anchor plate.

Wherever a transverse direction is mentioned in the application documents, this is understood as a direction transverse to the longitudinal extension of the picking gap. The picking gap typically extends parallel to the direction of travel of the harvesting machine into the crop material. A rotatory movement is understood as a rotating or pivoting movement.

According to one embodiment of the invention, each picking plate that is adjustable in the transverse direction is connected to two separate anchor plates via one joint axis each, the anchor plates being arranged spaced apart from one another along the picking gap. The use of two anchor plates that are spaced apart from one another and that together adjust the picking plates connected to them in the transverse direction enables a uniform parallel displacement of the lateral edges of the picking plates that delimit the picking gap, so that an adjusting movement changes the width of the picking gap over its length, controlled uniformly by the anchor plates.

According to one embodiment of the invention, the anchor plates are located on the upper side of a longitudinal beam, each such longitudinal beam being located between two adjacent picking gaps. On the upper side of the longitudinal beam, the anchor plates are in a protected zone where they cannot be damaged by obstacles and their functioning cannot be impaired by plant parts lying on the ground or carried along by the anchor plates during harvesting when the device is being driven close to the ground. The risk of soiling is decreased, and maintenance work performed from above is facilitated.

According to one embodiment of the invention, the anchor plates are located below the conveying units assigned to a longitudinal beam. The anchor plates are covered and additionally protected by the conveying units. The vertical layering of the anchor plates and the associated adjustment mechanism along with the conveying units results in a decreased overall width, which is of considerable importance for the practicability of 15-inch row widths.

According to one embodiment of the invention, the shafts of the deflecting wheels of the conveying units are set at an oblique setting angle relative to the picking gap plane. The conveying units are therefore tilted and project above the anchor plates in the manner of a pitched roof, further decreasing the overall width. The arrangement of the conveying units in the manner of a pitched roof creates installation space below said units, in which the anchor plates can be effectively arranged without having to raise the plane of the picking gap or the conveying plane of the conveying units for this purpose. The picking gap plane is defined by the spatial position of a straight line connecting the sides of the picking plates that face the picking gap to one another.

According to one embodiment of the invention, anchor plates are mounted each on a respective shaft for rotation therewith, said shaft extending downward through the longitudinal beam to the underside of the longitudinal beam, and the adjusting lever is connected to the shaft for rotation therewith. The respective shafts and the actuation thereof from the underside of the device allows the longitudinal levers to be located on the underside of the device, where they cannot impede the entry of the cornstalks into the picking gap or the picking operation in the picking units. Each of the adjusting levers can extend from the point of attachment to the shaft in the direction of the rear side of the device, so that they extend only a small distance in the transverse direction toward the direction of travel of the harvesting machine. The adjusting levers therefore have only a small end surface with which the adjusting levers might collide with obstacles or residual crop material. The adjusting levers can be readily accessed and easily operated at the back side of the device. A plurality of adjusting levers may be connected to one another via a coupling rod, the actuation of which allows a plurality of picking plates to be adjusted by a desired amount simultaneously with one adjusting movement.

According to one embodiment of the invention, anchor plates located downstream of the picking gap are each mounted on a respective shaft, which extends downward through the longitudinal beam to the underside of the longitudinal beam, and these anchor plates, which are located downstream of the picking plates, are each connected to an anchor plate located upstream of the picking gap via a linkage arm, which extends in the longitudinal direction of the longitudinal beam, and via which a rotatory movement of the downstream anchor plate is transmitted to the upstream anchor plate. The linkage arms extending in the longitudinal direction of the longitudinal beam are located protected on the top of said longitudinal beam. In addition, they utilize the available installation space beneath the conveying units, without increasing the overall width of the device.

According to one embodiment of the invention, the linkage arm is configured as variable in length. The zero position of the anchor plate actuated by the linkage arm is adjusted by changing the length of the linkage arm. Under normal circumstances, the length of the linkage arm is such that the mutually facing sides of the picking plates are aligned parallel to one another. Shortening or extending the length of the linkage arm over that of this normal case forces the anchor plate to rotate toward or away from the other anchor plate according to the adjusted length of the linkage arm. The transmission of this rotatory movement to the picking plate causes a shift in the position of the picking plate. This causes a change in the rectangular basic shape of the picking gap to a trapezoidal shape, in which the picking gap is narrower toward the front or toward the rear, depending on the direction of the change in length, because the sides of the picking plates are no longer parallel to one another. The change in length may involve a manual or a motorized adjustment, and in the case or a motorized adjustment may be remotely actuated, for example from the cab of a combine harvester.

According to one embodiment of the invention, the picking plates are held in longitudinal guides. Guiding the picking plates in longitudinal guides causes adjusting movements of the anchor plates to result in defined movements of the picking plates. This enables the picking plates to be adjusted very precisely to a picking gap of a specific desired width.

It is expressly understood that the above-described embodiments of the invention can each be combined individually, or in any combination with one another, with the subject matter of the main claim.

Further modifications and embodiments of the invention may be found in the following subject matter description and in the set of drawings.

The invention will be described below in reference to an exemplary embodiment. The drawings show:

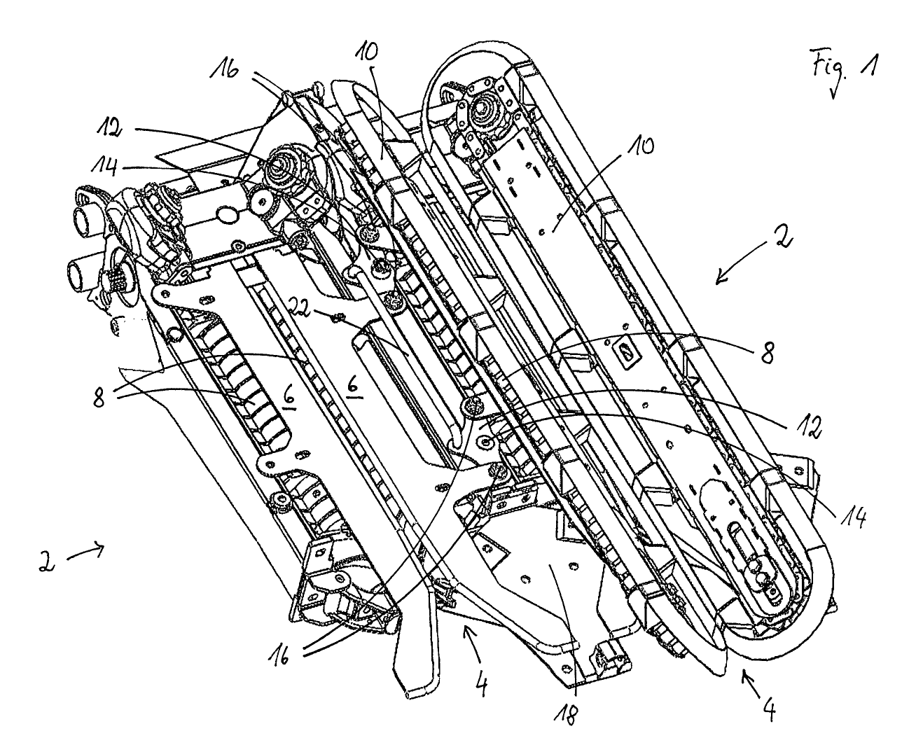

FIG. 1: a view obliquely from above of two picking rows of a device,

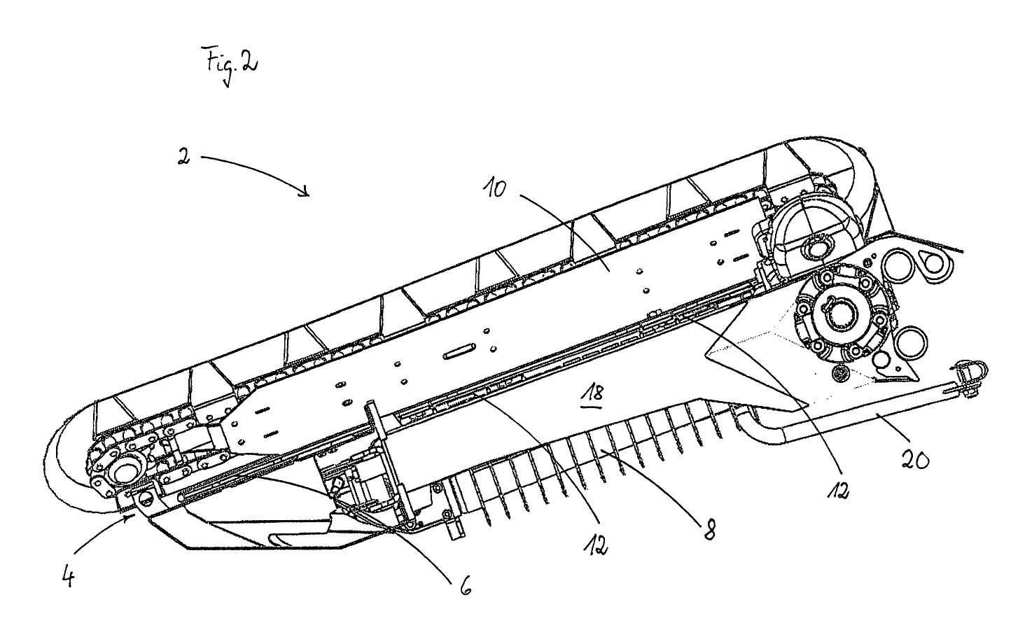

FIG. 2: a side view of a picking unit,

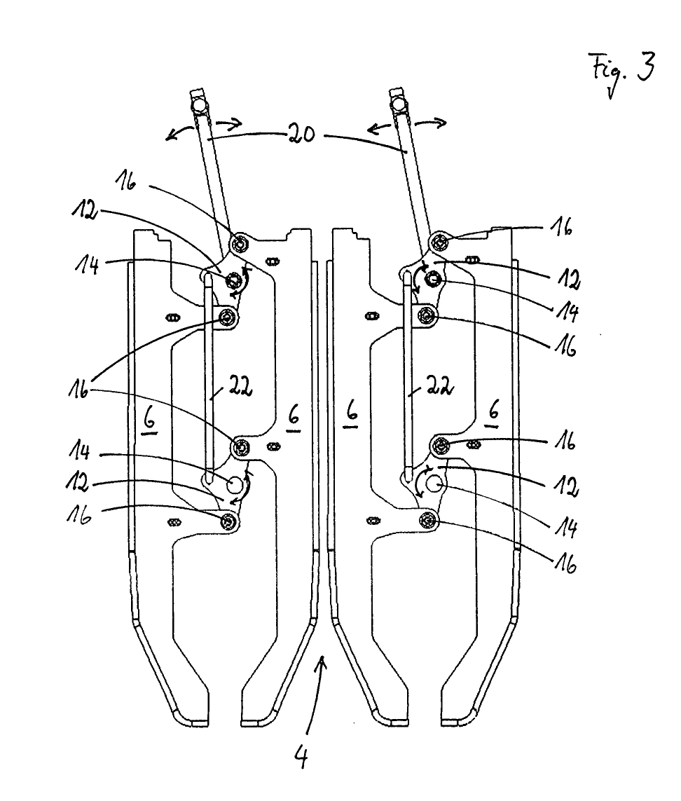

FIG. 3: a view of the picking plate adjustments for two pairs of picking plates,

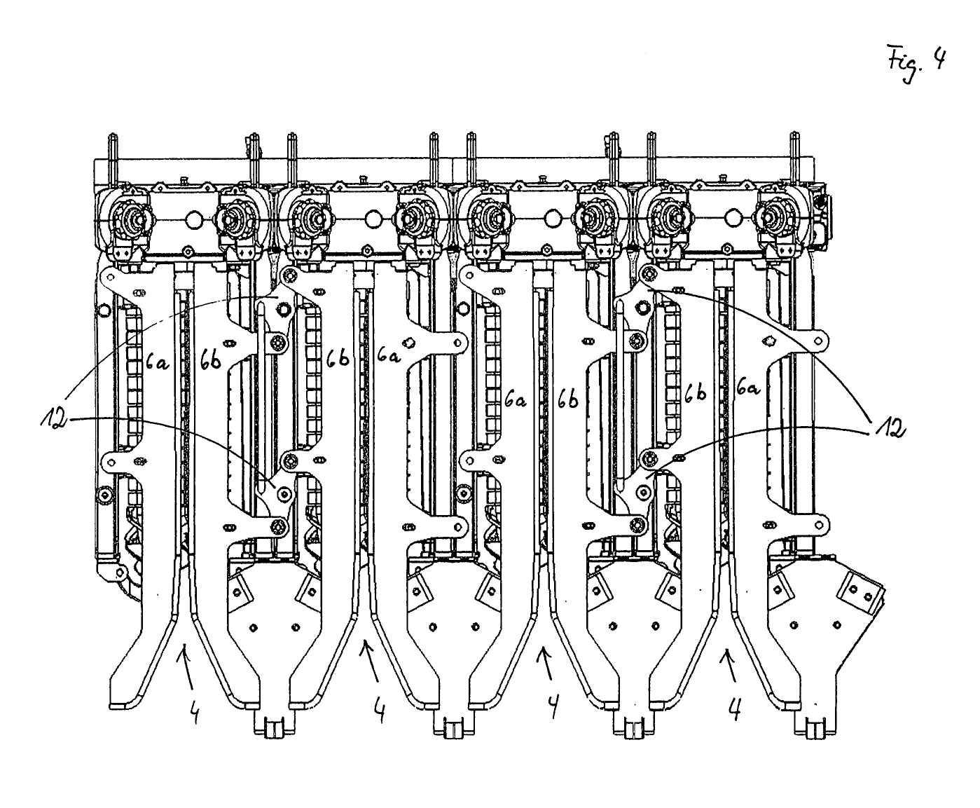

FIG. 4: a view from below of a device having one stationary picking plate per picker row, and

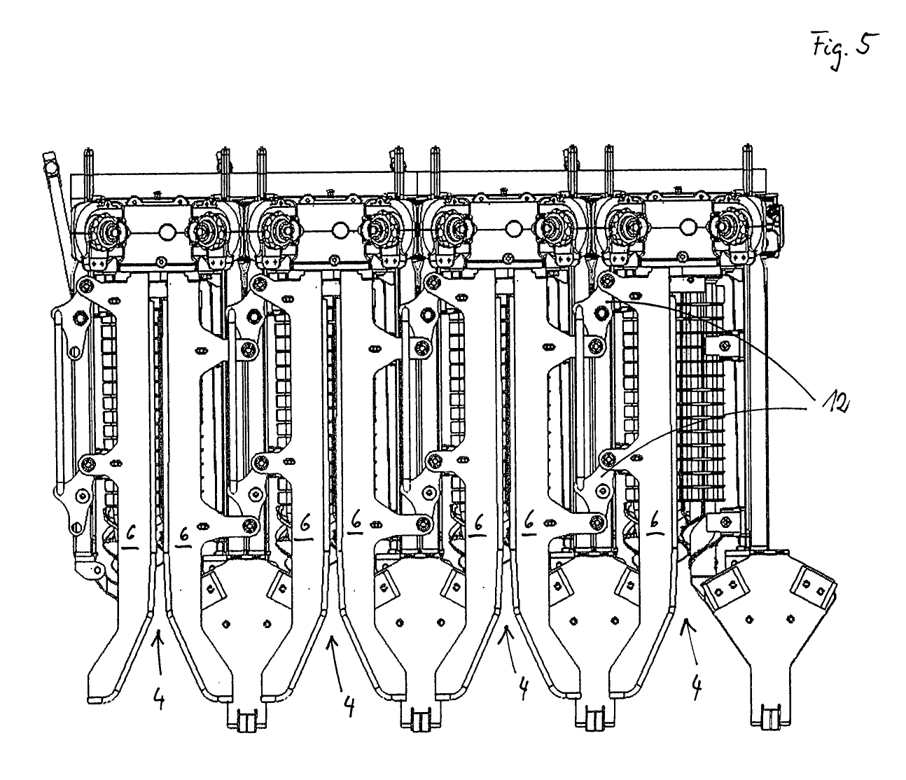

FIG. 5: a view from below of a device having two movably adjustable picking plates per picker row.

FIG. 1 shows an oblique view from above of two picking rows of a corn picker, in which the left picking unit 2 is shown partially disassembled. The two picking units 2 each have a picking gap 4, which is bordered laterally by picking plates 6. Picking rotors 8 are arranged below the picking plates 6, and conveying units 10 are arranged above the picking plates. In the picking unit 2 on the right, the envelope curve of the carrier elements attached to the circulating conveyors is represented graphically as an orbit. The axes of the deflecting wheels of the two circulating conveyors are tilted in relation to the plane of the picking plates 6 and the plane of the picking gap delimited by said plates.

The removal of the conveying units 10 from the picking unit 2 on the left allows an oblique view from above of the two anchor plates 12, which are fixedly connected to rotational axis 14 and are co-rotatable with rotational axis 14. In the two anchor plates 12, joint axes 16 are formed, via which the anchor plates 12 are connected to adjacent picking plates 6. Each anchor plate 12 has two joint axes 16 connecting said anchor plate 12 to a picking plate 6.

The two anchor plates 12 are located on the upper side of a longitudinal beam 18. The longitudinal beam 18 is attached to a transverse frame of a corn picker, located at the downstream end of a picking unit 2. The longitudinal beam 18 serves the purpose of attaching the individual components of a picking unit 2 thereto. The longitudinal beams 18 are typically located between the picking gaps 4, so that the flow of crop material through the picking gap 4 is not impeded during harvesting.

In the exemplary embodiment shown, axis of rotation 14 is rotated by an adjusting lever 20, which is not shown in detail in FIG. 1. However, linkage arm 22 that connects the two anchor plates 12 to one another is visible in FIG. 1. When one of the two anchor plates 12 executes a rotatory movement, this movement is transmitted via linkage arm 22 to the other anchor plate 12.

FIG. 2 shows a side view of a picking unit 2. In the side view, the tilted plane in which the picking plates 6 are disposed sloping upward from the front to the rear is visible. In the direction transversely to the longitudinal axis of picking gap 4, however, picking plates 6 are disposed nearly horizontally. As is clear from the side view, conveying units 10 are located above anchor plates 12, which are in turn located on the upper side of longitudinal beam 18. As is also clear from the side view, adjusting lever 20, which acts on the axis of rotation 14 of the downstream anchor plate 12, is located below longitudinal beam 18. Adjusting lever 20 extends rearward from axis of rotation 14 to the downstream end of the device. There, adjusting lever 20 can be connected to a coupling rod, via which a uniform adjustment of the picking plates of a plurality of picking units 2 is possible.

Also located below longitudinal beam 18 are the picking rotors 8. Positioning the adjustment device for the transverse adjustment of the picking plates 6 between conveyor unit 10 and longitudinal beam 18 decreases the overall width in the transverse direction up to picking gap 4, but without significantly increasing the overall height of a picking unit 2 as a result.

FIG. 3 shows a view of picking plate adjustments for one center picking gap and two picking gaps 4 adjacent thereto. Every two picking plates 6 form a pair, which is adjustable in the transverse direction via two common anchor plates 12.

As is clear from the view from above, the four anchor plates 12 can likewise be rotated about axis of rotation 14 by a corresponding actuation of adjusting lever 20 in the direction indicated by the arrows. A corresponding rotatory movement causes the joint axes 16 to shift accordingly. Since picking plates 6 are connected via joint axes 16 to anchor plates 12, a pivoting movement of anchor plates 12 also automatically produces a transverse displacement of picking plates 6. A transverse displacement of picking plates 6 alters the width of picking gap 4 based upon the direction in which picking plates 6 are moved.

In the exemplary embodiment, adjusting the two pairs of picking plates 6 by actuating the two adjusting levers 20 will cause the movement of a total of four picking plates 6, of which two picking plates 6 delimit the center picking gap 4, and two outer individual picking plates 6 each form one side of an adjacent picking gap 4.

FIG. 4 shows a view from below of a device having one stationary picker plate 6a per picking unit 2. In each of the picking units 2 shown, only one picking plate 6b can be adjusted in the transverse direction, in each case via two anchor plates 12.

FIG. 5 shows a view from below of an embodiment of a device in which, in each picking unit 2, both picking plates of a respective picking unit 2 are movable in the transverse direction via anchor plates 12.

FIGS. 4 and 5 thus illustrate two different embodiments, in which either only one picking plate 6 per picking gap 4 is adjustable in the transverse direction and the picking plate is rigidly connected to the longitudinal beam 18, or both picking plates 6 per picking gap 4 are adjustable, with one anchor plate 12 actuating only one picking plate 6 per picking gap 4, or actuating one picking plate from each of two adjacent picking gaps 4.

The exemplary embodiment described above is intended merely to illustrate the invention. The invention is not limited to the exemplary embodiment shown. A person skilled in the art will have no difficulty modifying the exemplary embodiment in a way that appears suitable to adapt it to a specific application.

What is claimed is:

1. A device for harvesting stalk-like stem crops, the device comprising:
a number of picking units (2), which are arranged side by side on the frame of the device and which each have picking plates (6) that laterally delimit a picking gap (4) and are adjustable in the transverse direction, and at least one picking rotor (8) located therebeneath,
conveying units (10), which are assigned to the respective picking units (2), are embodied as continuous conveyors that are driven in circulation, are arranged on opposite sides above a picking gap (4), and have carrier elements attached to the circulating conveyors, and
a transverse conveying device located downstream of the conveying units (10), wherein the transverse adjustment of the picking plates (6) is carried out by means of anchor plates (12), which can be moved in rotation about an axis of rotation (14) by means of an adjusting lever (20), characterized in that one or more anchor plates (12) each have two joint axes (16) via which adjacent picking plates (6) are connected to said anchor plate (12), and when these anchor plates (12) are rotated about their axes of rotation, the two picking plates (6) can be moved in the transverse direction via the joint axes (16).

2. The device according to claim 1, characterized in that each picking plate (6) that is adjustable in the transverse direction is connected to two separate anchor plates (12) via a respective joint axis (16) each, wherein the anchor plates (12) are arranged spaced apart from one another along the picking gap (4).

3. The device according to claim 1, characterized in that the anchor plates (12) are located on the upper side of a longitudinal beam (18), each such beam being located between two adjacent picking gaps (4).

4. The device according to claim 3, characterized in that the anchor plates (12) are located below the conveying units (10) that are associated with a longitudinal beam (18).

5. The device according to claim 4, characterized in that the shafts of the deflecting wheels of the conveying units (10) are set at a tilted setting angle in relation to the picking gap plane.

6. The device according to claim 3, characterized in that anchor plates (12) are mounted each on a respective shaft for rotation therewith, said shaft extending downward through the longitudinal beam (18) to the underside of the longitudinal beam (18), and the adjusting lever (20) is connected to the shaft for rotation therewith.

7. The device according to claim 2, characterized in that anchor plates (12) located downstream of the picking gap (4) are mounted each on a respective shaft, which extends downward through the longitudinal beam (18) to the underside of the longitudinal beam (18), and each of these anchor plates (12) located downstream of the picking plates (6) is connected to an anchor plate (12) located upstream of the picking gap (4) via a linkage arm (22), which transmits a rotatory movement of the downstream anchor plate (12) to the upstream anchor plate (12).

8. The device according to claim 7, characterized in that the linkage arm (22) is configured as adjustable in length.

9. The device according to claim 1, characterized in that the picking plates (6) are held in longitudinal guides.
